(19) United States
(12) Patent Application Publication
(10) Pub. No.: US 2023/0304939 A1
(43) Pub. Date: Sep. 28, 2023

(54) DYNAMIC ILLUMINATION INSPECTION TUNNEL

(71) Applicant: VIRELUX INSPECTION SYSTEMS SARL, DIFFERDANGE (LU)

(72) Inventors: Tom REICHERT, DIFFERDANGE (LU); Gerard BASEOTTO, Marly (FR)

(21) Appl. No.: 18/011,337

(22) PCT Filed: Jun. 17, 2021
(86) PCT No.: PCT/EP2021/066473

§ 371 Date: Dec. 19, 2022

(30) Foreign Application Priority Data
Jun. 17, 2020 (LU) LU101861

(51) Int. Cl. G01N 21/88

(52) U.S. Cl. CPC G01N 21/8806; G01N 2021/8816; G01N 2021/8835

(57) ABSTRACT

An inspection tunnel for illuminating an outer surface of an object to be inspected, comprising a frame with an arch shape of the inspection tunnel; light sources distributed on an inner face of the frame, configured for illuminating the outer surface of the object; a light diffusing screen with an arch shape and extending in front of the light sources; wherein the light diffusing screen contacts at least some of the light sources.

The present invention is the US national stage under 35 U.S.C. § 371 of International Application No. PCT/EP2021/066473 which was filed on Jun. 17, 2021, and which claims the priority of application LU101861 filed on Jun. 17, 2020 the contents of which (text, drawings and claims) are incorporated here by reference in its entirety.

### FIELD

The invention is directed to the field of surface inspection, more specifically of surface inspection by reflection of light, e.g., by deflectometry.

### BACKGROUND

Prior art patent document published WO 2019/223847 A1 discloses an inspection tunnel for illuminating reflective outer surfaces of an object, like a vehicle, to be inspected. The tunnel is generally arch-shaped, comprising a frame forming about half a circle and a series of light sources of the light emitting diode (LED) type carried by the frame. The LEDs are arranged in a grid on a circuit board that is curved or initially planar and thereafter bent for forming the arch. A light diffusing or scattering sheet is provided in vis-à-vis of the LEDs at a distance therefore by providing spacers between the circuit board and the light diffusing or scattering sheet. This results in a double-walled construction specifically designed for achieving a homogenous light distribution over the whole light diffusing or scattering sheet, i.e., with less than 30% light intensity variation. This inspection tunnel is specifically designed for providing a homogeneous illumination while being of a lightweight, mobile and modular construction. This inspection tunnel is not designed for deflectometry, i.e., detection of surface defects by deformation of an illumination pattern.

Prior art patent document published DE 101 29 972 A1 discloses, similarly to the preceding document, an inspection tunnel for illuminating reflective outer surfaces of an object, like a vehicle, to be inspected. The inspection tunnel is arch-shaped and comprises a grid of light sources of the LED type and a light diffusing or scattering sheet arranged in vis-à-vis of the LEDs at a distance thereof also for achieving a homogenous light distribution.

Prior art patent document published DE 20 2004 009 194 U1 discloses, similarly to the preceding documents, an inspection tunnel for illuminating reflective outer surfaces of an object, like a vehicle, to be inspected. The inspection tunnel comprises a series of modules adjacent side by side and oriented along a main axis of the inspection tunnel. Each module comprises a flat substrate carrying LEDs on one side and cooling rips on the other opposite side. Planar light diffusing or scattering sheets are arranged in vis-à-vis of the LEDs at a distance thereof for achieving a homogenous light distribution.

Prior art patent document published WO 2009/007129 A1 discloses an inspection tunnel for illuminating reflective outer surfaces of an object, like a vehicle, to be inspected. The tunnel is also arch-shaped and can comprise a grid of light sources of the LED type arranged on the inner side of the inspection tunnel and configured for producing an illuminating pattern with alternating bright and dark stripes. The inspection tunnel comprises also cameras arranged for capturing images of the illumination pattern reflected by the outer surface of the object to be inspected. The object to be inspected, for instance a vehicle, is moved through the inspection tunnel by means of a moving platform. The images captured during movement of the object through the inspection tunnel are thereafter processed for detection of surface defect. The image processing by deflectometry is however not detailed. The main purpose and advantage of this inspection tunnel is that the illumination pattern is static and can therefore be achieved with cheap and simple means. The inspection tunnel according to this teaching requires to be of a certain length so as to ensure that each of the several cameras captures images of the pattern reflected by the outer surface of the object being inspected.

### SUMMARY

The invention has for technical problem to overcome at least one of the drawbacks of the above cited prior art. More particularly, the invention has for technical problem to provide an inspection tunnel of a more compact and more efficient design.

The invention is directed to an inspection tunnel for illuminating an outer surface of an object to be inspected, comprising: a frame with an arch shape of the inspection tunnel; light sources distributed on an inner face of the frame, configured for illuminating the outer surface of the object; a light diffusing screen with an arch shape and extending in front of the light sources; wherein the light diffusing screen contacts at least some of the light sources.

According to an exemplary embodiment, the light diffusion screen forms a continuous arch-shaped strip with two ends and held in contact with the light sources by a pressing force at the two ends.

According to an exemplary embodiment, the pressing force at the two ends of the continuous strip is achieved by a stop piece against each of the two ends, respectively.

Advantageously, each stop piece comprises a support rigidly attached to the frame, a rail engaging with an edge portion of the light diffusing screen and means for adjusting the relative position between the support and the rail. These means can be tightening screws. The rail can show a slot receiving the edge portion of the light diffusing screen.

According to an exemplary embodiment, the light diffusion screen comprises a first transparent layer contacting the light sources and a second diffusing layer superimposed on the first transparent layer and forming an outer surface of the inspection tunnel.

According to an exemplary embodiment, the inspection tunnel further comprises boxes arranged side by side and extending along a main axis of the inspection tunnel, the boxes being carried by the frame and supporting the light sources.

According to an exemplary embodiment, each box carries one or more circuit boards provided with the light sources oriented towards the main axis of the inspection tunnel.

According to an exemplary embodiment, each box forms an inner volume with air contacting a rear face of the light sources so as to cool the light sources.

According to an exemplary embodiment, the light sources supported by each of the boxes forms a grid with a pitch of not more than 10 mm and/or of at least 4 mm.

According to an exemplary embodiment, the inspection tunnel shows an inner mean radius, each box showing a width of not more than 10%, in various instances not more than 8%, of the mean radius.

According to an exemplary embodiment, the inspection tunnel further comprises a control unit for individually operating the light sources. The control unit can consist of several sub-units electrically connected to each other and possible arranged at different locations on the inspection tunnel.

According to an exemplary embodiment, the light sources and the control unit are configured for selectively forming different illumination patterns.

According to an exemplary embodiment, at least one of the illumination patterns forms alternating bright and dark stripes with a progressive grey-level variation there between, various instances of sinusoidal shape.

According to an exemplary embodiment, the at least one illumination pattern is periodic with a period and an orientation that each can be varied.

According to an exemplary embodiment, the different illumination patterns can selectively be static or dynamic by moving along a direction, various instances along a main axis of the inspection tunnel.

According to an exemplary embodiment, the dynamic illumination patterns move with a speed that is adjustable.

According to an exemplary embodiment, the control unit comprises an input for a signal representative of a speed of the object to be inspected relative to the inspection tunnel, the control unit being configured for adjusting the speed of the dynamic illumination patterns at a value that is less than the speed of the object to be inspected.

According to an exemplary embodiment, the inspection tunnel further comprises at least one camera arranged for capturing images of the illumination patterns reflected by the outer surface of the object to be inspected.

According to an exemplary embodiment, the control unit is configured for processing the images captured by the at least one camera in order to identify by deflectometry surface defects.

According to an exemplary embodiment, the processing of the images captured by the at least one camera uses phase shifting deflectometry.

The invention can also be directed to an inspection tunnel for illuminating an outer surface of an object to be inspected, comprising: a frame with an arch shape of the inspection tunnel; light sources distributed on an inner face of the frame, configured for illuminating the outer surface of the object; a control unit for individually operating the light sources, wherein the light sources and the control unit are configured for selectively forming different illumination patterns.

According to an exemplary embodiment, at least one of the illumination patterns forms alternating bright and dark stripes with a progressive grey-level variation there between, various instances of sinusoidal shape.

According to an exemplary embodiment, the at least one illumination pattern is periodic with a period and an orientation that each can be varied.

According to an exemplary embodiment, the different illumination patterns can selectively be static or dynamic by moving along a direction, various instances along a main axis of the inspection tunnel.

According to an exemplary embodiment, the dynamic illumination patterns move with a speed that is adjustable.

According to an exemplary embodiment, the control unit comprises an input for a signal representative of a speed of the object to be inspected relative to the inspection tunnel, the control unit being configured for adjusting the speed of the dynamic illumination patterns at a value that is less than the speed of the object to be inspected.

According to an exemplary embodiment, the inspection tunnel further comprises at least one camera arranged for capturing images of the illumination patterns reflected by the outer surface of the object to be inspected.

According to an exemplary embodiment, the control unit is configured for processing the images captured by the at least one camera in order to identify by deflectometry surface defects.

According to an exemplary embodiment, the processing of the images captured by the at least one camera uses phase shifting deflectometry.

The invention is particularly interesting in that the performance of the inspection tunnel is substantially improved.

Indeed, the contact between the light diffusion screen and the light sources allows to keep a sufficiently high resolution of the image while avoiding the image to show pixels. It also simplifies the assembling operations of the inspection tunnel.

The use of boxes for supporting the light sources is also interesting in that it allows an efficient cooling of the light sources and also provides a continuous grid of the light sources formed by a series of circuit boards juxtaposed to side by side. The light sources can be provided on planar circuit boards, commercially available at a limited cost. The light sources and the light diffusion screen form an illumination display with a resolution that is sufficiently high for producing illumination patterns useful in deflectometry, i.e., fringe patterns with a width that can be comprised between 10 mm and 200 mm, various instances between 20 mm and 150 mm, for example between 30 mm and 120 mm.

The production of selectively different illumination patterns is particularly useful for adapting the relevance of the pattern to the outer surface to be inspected, e.g., the shape of the surface and/or the type of surface defects to be detected. The production of fringe patterns with a square-shaped sectional brightness profile can be useful for detecting larger defects like dents in a bodywork, whereas the production of fringe patterns with a sinusoidal sectional brightness profile can be useful for detecting smaller defects like grain or fibre inclusions in paint of a bodywork.

The production of dynamic patterns, i.e., moving patterns is also particularly interesting in that it allows to control, e.g., reduce, the relative speed between a moving object to be inspected and the illumination pattern, thereby increasing the inspection conditions, i.e., comfort, for inspection staff.

### DRAWINGS

FIG. 1 is a front perspective view of an inspection tunnel according to various embodiments of the invention.

FIG. 2 is a top perspective view of the central portion of the inspection tunnel of FIG. 1 according to various embodiments of the invention.

FIG. 3 is a perspective view of the boxes and light diffusing screen of the central portion of the inspection tunnel of FIG. 2 according to various embodiments of the invention.

FIG. 4 is a perspective view of a box of the inspection tunnel of FIGS. 1 to 3 according to various embodiments of the invention.

FIG. 5 is a front view of a box of the central portion of the inspection tunnel of FIGS. 1 to 3 according to various embodiments of the invention.

FIG. 6 is an exploded view of the central portion of inspection tunnel of FIGS. 1 to 3 according to various embodiments of the invention.

FIG. 7 is an exploded view of a possible configuration for the light diffusion screen according to various embodiments of the invention.

FIG. 8 is a detailed perspective view of a portion of a stop piece of FIG. 6 according to various embodiments of the invention.

FIG. 9 illustrates a portion of the light diffusion screen contacting the light sources according to various embodiments of the invention.

FIG. 10 is a schematic view illustrating the principle of detection of surface defects with the inspection tunnel of the invention according to various embodiments of the invention.

FIG. 11 shows two types of illumination patterns that can be produced by the inspection tunnel of the invention according to various embodiments of the invention.

FIG. 12 shows reflected images of the illumination patterns of FIG. 11 according to various embodiments of the invention.

FIG. 13 shows reflected images of two sinusoidal perpendicular sinusoidal illumination patterns according to various embodiments of the invention.

FIG. 14 shows two sinusoidal illumination patterns with different periods, illustrating a dynamic change of period according to various embodiments of the invention.

FIG. 15 illustrates the effect of a dynamic illumination pattern compared with a static one according to various embodiments of the invention.

### DETAILED DESCRIPTION

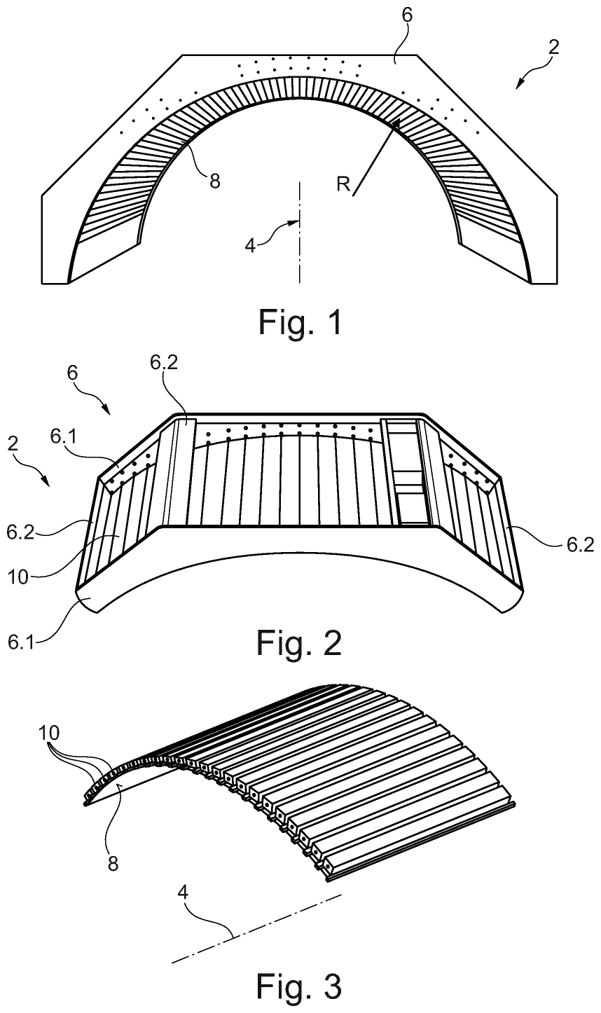

FIGS. 1 to 3 are different views of an inspection tunnel according to various embodiments of the invention.

As this is apparent, the inspection tunnel 2 is generally arch-shaped with a main axis 4. The arch shape can be a portion of an arc, i.e., with a constant radius R or can show a more complex profile with a varying radius R. The inspection tunnel 2 comprises a frame 6 with the arch shape of the inspection tunnel. The frame carries a grid of light sources (not visible in FIGS. 1-3) and a light diffusing screen 8 arranged in vis-à-vis of the light sources. The inspection 2 further comprises boxes 10 arranged adjacent to each other side by side and oriented along the main axis 4. The boxes 10 are carried by the frame 6 and support the light sources. The boxes are arranged along the arch shape of the frame 6 to as to produce with the light diffusing screen 8 an arch-shaped illuminating surface oriented towards the main axis 4.

The inspection tunnel can be modular, i.e., made of distinct portions assembled together. For instance, the inspection tunnel 2 in FIG. 1 can be complemented at its lower ends by additional modules so as to form an arch shape that extend over a sector of more than 180°, e.g., more than 200°, various instances more than 220°.

FIG. 2 illustrates the central portion of the inspection tunnel of FIG. 1. The frame 6 comprises for instance two transversal beams 6.1 that are generally arch-shaped and several longitudinal beams 6.2 interconnecting the two arch-shaped transversal beams 6.1. The boxes 10 extend longitudinally between the two arch-shaped transversal beams 6.1 and are attached thereto by means of fastening brackets (not visible).

With reference to FIG. 3, the light diffusing screen 8 conforms to the curved profile of the boxes 10, i.e., according to the arch-shaped profile of the two transversal beams 6.1. To that end, the light diffusing screen 8 is pressed against the grid of light sources supported by the boxes.

The frame 6, i.e., the transversal beams 6.1 and longitudinal beam 6.2 are advantageously made of metal, e.g., steel, being however understood that other materials can be considered.

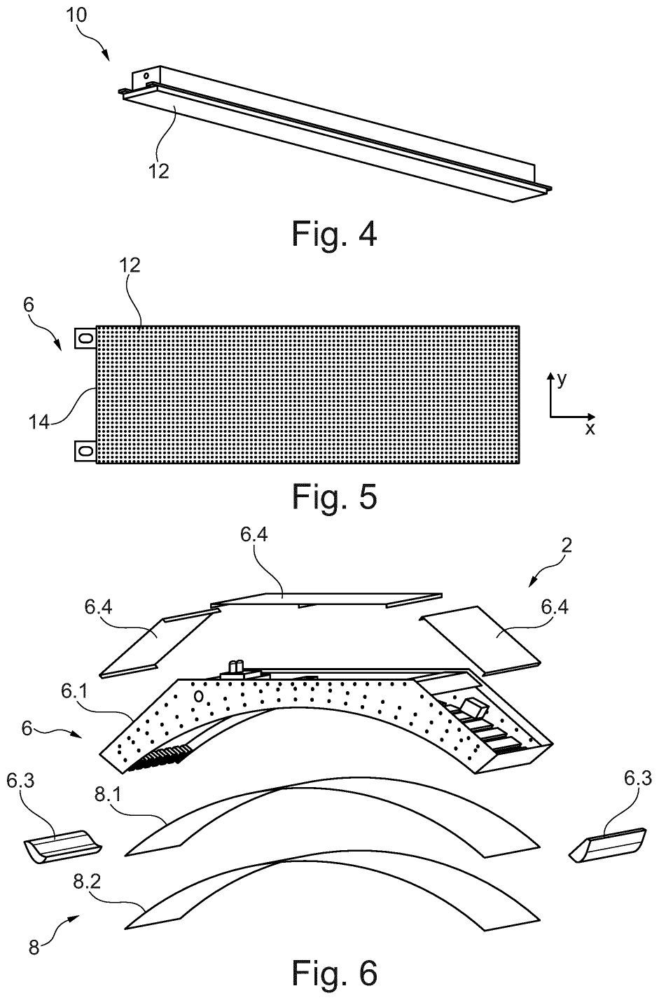

FIGS. 4 and 5 are two views of one of the boxes 10 according to various embodiments of the invention.

As this is apparent, each box 10 extends along a longitudinal direction and supports on one main face the light sources 12. The latter are arranged in a grid with a pitch that can be comprised between 4 and 10 mm. The light sources 12 are of the LED type and are arranged advantageously with the same pitch in the two x and y directions. They are arranged on one or several circuit boards 14 which are mounted on the boxes 10. Each box 10 can comprise several circuit boards arranged adjacent side by side so as to form a continuous and homogeneous grid of light sources over the whole box. More specifically, each box 10 can be generally cuboid with a main open face that is covered by the one or more circuit boards 14. The inner volume of the box 10 contains air that contacts a rear face of the one or more circuit boards 14. A natural or forced circulation of that air in the inner volume can achieve a cooling of the light sources 12. One or several electric fan can be provided on the box 10 for forcing an air circulation. Inlet and outlet vents (not represented) can be provided on the box for allowing a proper air circulation, i.e., natural or forced.

The one or more circuit boards 14 supporting the light sources 12 can be connected to a dedicated driver mounted on the box 10 or outside of the box, for instance on the frame 6 of the inspection tunnel 2 (FIGS. 1 and 2). Each light source 12 can be individually controlled in light intensity and also advantageously in color colour. The circuit boards 14 with the grid of light sources 12 and suitable drivers are commercially available and therefore do not need to be further detailed.

Advantageously, each box 10 forms a flange around the main open face that supports the one or more circuit boards 14 with the light source 12, the flange receiving the outer sides of the one or more circuit boards 14 with the light source 12.

Advantageously, each circuit board 14 with the light source 12 extends transversally up to or even beyond the edge of the corresponding flange so as to be directly adjacent the circuit board of the neighbouring box 10, thereby providing a continuous grid of light sources along the arch-shaped profile of the inspection tunnel.

The boxes 10 are advantageously made of metal, e.g., steel, being however understood that other materials can be considered.

FIG. 6 is an exploded view of the central portion of the inspection tunnel 2 of FIG. 2. It can be observe that the light diffusing screen 8 comprises a first layer 8.1 contacting the light sources on the boxes (not visible) and a second layer 8.2 superimposed on the first layer 8.1 opposite to the light sources. The first layer 8.1 is advantageously transparent and the second layer 8.2 is advantageously a light diffusing layer, e.g., with a grainy surface and/or with diffusing particles inside the transparent or translucent material thereof. The light diffusing screen 8 form a continuous strip with two ends abutting the stop pieces 6.3 attached to the transversal beams 6.1 of the frame 6. The stop pieces 6.3 are designed for exerting a pressure on the end faces of the light diffusing screen 8, for instance of each of the first layer 8.1 and the second layer 8.2. This pressure allows the one or several layers forming the light diffusing screen 8 to deform and conform to the profile of the light sources supporting the light sources. The conformation results in the inner and upper side of the light diffusing screen 8 to contact most, i.e., more than 50%, various instances more than 60%, for example more than 70%, of the light sources.

The frame 6 can comprise panels 6.4 covering the upper face thereof.

The close contact between the light diffusing screen 8 and the light source allows forming accurate illumination patterns while avoiding the formation of visible pixels. Indeed, without the light diffusing screen 8, the illumination beam produced would show as many pixels as the light sources whereas with a light diffusing screen arranged at a distance from the light sources, as in the prior art, would homogenise the illumination beam up to a point that only smooth brightness transition will be produced, i.e., no sharp transitions. Positioning the light diffusing screen 8 relative the light sources at a constant distance can be difficult at such large scale. Elastically pressing the light diffusing screen 8 against the light sources is therefore particularly interesting in that it achieves a best compromise between image sharpness and pixel effect while providing an accurate and simple mounting.

Also, the use of two superimposed first transparent layer 8.1 and a second diffusion layers 8.2 is interesting in that it limits the diffusion of light to the second layer 8.2. The first layer 8.1 transmits light with nearly no diffusion whereas the second layer 8.2 transmits and diffuses light. The thickness and properties of the second layer 8.2 can be selected to adjust the level of light diffusion.

The construction of the central portion of the inspection tunnel which has been described above applies to optional additional portions or modules of the inspection tunnel.

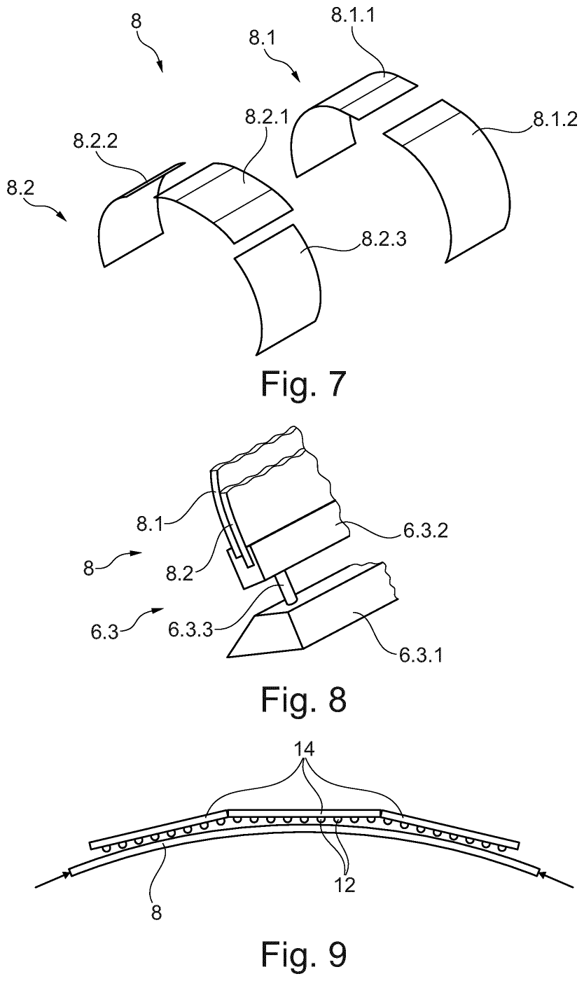

FIG. 7 is a perspective and exploded view of a possible configuration of the light diffusing screen 8. As this is apparent, the first layer 8.1 is composed of two segments 8.1.1 and 8.1.2 which are for instance symmetric relative to a longitudinal plane. The second layer 8.2 is composed of three segments, for instance a central one 8.2.1 and two lateral ones 8.2.2 and 8.2.3 which are for instance symmetric. It results that the segmentation of both layers 8.1 and 8.2 are off-set in order to limit the optical disturbance at the junction between two adjacent segments. A superimposition of two junctions between adjacent segments of the layers would indeed intensify the optical perturbation at the junctions. On a mechanical adjustment and fitting point of view, the off-set arrangement is also particularly interesting in that it helps in aligning the adjacent end faces of the segments. The number of segments and their distribution can be different from the one illustrated in FIG. 7.

FIG. 8 is a detailed view of a portion of a stop piece 6.3 as illustrated in FIG. 6. The stop piece 6.3 comprises a support 6.3.1 that extends along the main axis of the inspection tunnel, a rail 6.3.2 extending also along the main axis of the inspection tunnel and with a slot receiving an edge portion of the light diffusing screen 8, and a series of tightening screws 6.3.3 engaging with the support 6.3.1 and with the rail 6.3.2. These tightening screws 6.3.3 extend essentially in the same plane as the edge portion of the light diffusing screen 8. The tightening screws 6.3.3 can finely adjust the position of the rail 6.3.2 relative to the support 6.3.1 and thereby exert a pressing force on the edge portion of the light diffusing screen 8.

As this is apparent, the rail 6.3.2 shows a slot in which the edge portion of the light diffusing screen 8 engages. The slot can show a stepped bottom face, as visible in FIG. 8, allowing the end portions of the different layers of the light diffusing screen 8 to be staggered.

FIG. 9 illustrates schematically a portion of the light diffusion screen contacting the light sources. It shows three adjacent circuit boards 14 supporting the light sources 12 and a corresponding portion of the light diffusing screen 8. The latter is schematically illustrated as a single layer being however understood that is can be multi-layered as detailed above. The pressing force exerted at the ends of the light diffusing screen 8 are illustrated by the two arrows. It allows the light diffusing screen 8 to nicely conform to the profile of the lights sources 12 supported by the circuit boards 14. This profile is not perfectly curved due to the planar shape of the circuit boards 14 whereas the light diffusing screen 8 takes a perfectly curved profile. A majority of the light sources 12 are contacted by the light diffusing screen 8. The light sources 12 not contacted by the light diffusing screen 8 are however at a very limited distance to the light diffusing screen 8, for instance less than 5 mm.

The circuit boards 14 are various instances planar and rigid. There is also a possibility of using flexible circuit boards supporting a grid of light sources. The boxes can then be constructed such as to show a curved cross-sectional profile at the main open face receiving the circuit board, thereby allowing the board to take a curved profile. Such a construction is however more expensive.

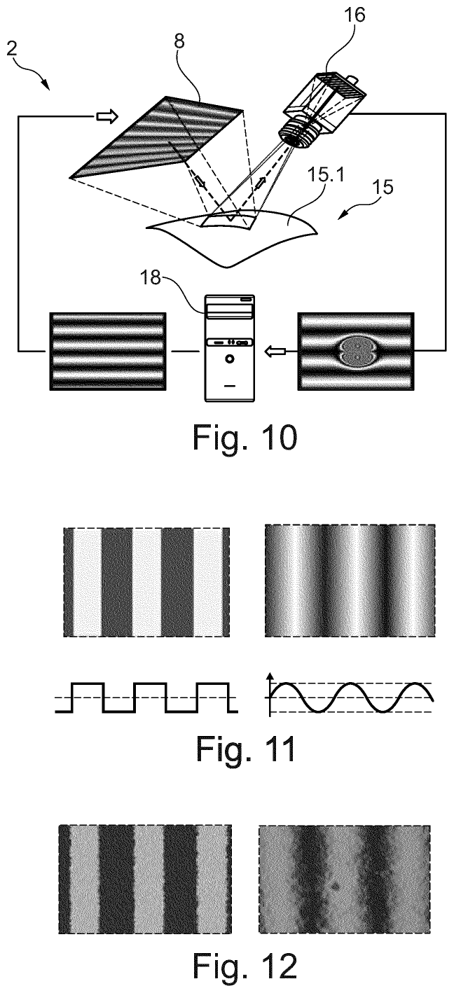

FIG. 10 is a schematic view illustrating the principle of detection of surface defects with the inspection tunnel of the invention according to various embodiments of the invention.

The inspection tunnel 2 can comprise at least one camera 16 and a control unit 18 or electronics for processing the images captured by the camera 16 and for controlling the illumination patterns emitted by the light diffusing screen 8 towards the object 15 whose outer surface 15.1 is to be inspected. The control unit 18, based on selection of parameters by a user, controls the light sources so as to form a given illumination pattern, for instance a fringe pattern composed of alternating bright and darks stripes. This pattern is emitted towards the object 15 to be inspected. Its reflecting outer surface 15.1 reflects this illumination pattern towards the camera 16. The latter captures images of the reflected illumination pattern. In case a defect is present on the illuminated outer surface 15.1 of the object 15, the defect will show substantially deformation of the fringes or stripes of the illumination pattern. This phenomenon is based on deflectometry where the local change of slope of the outer surface 15.1 at the defect substantially changes the shape of the pattern reflected by the outer surface. This renders the defect more visible and detectable while processing the images. Indeed, the image processing can determine the border between the bright and dark stripes based on the light intensity values of the pixels.

FIG. 11 shows two illumination patterns that the inspection tunnel according to various embodiments of the invention can produce, i.e., a first pattern of alternating bright and dark stripes with a sharp brightness variation between the stripes and a second pattern of alternating bright and dark stripes with a progressive brightness variation between the stripes. The first pattern is illustrated at the left of FIG. 8 whereas the second pattern is illustrated at the right of FIG. 8. The first pattern shows for instance a rectangular sectional brightness profile whereas the second pattern shows a sinusoidal sectional brightness profile. These two patterns can be produced by the inspection tunnel according to the construction described above, i.e., essentially thanks to the resolution of the grid of light sources, i.e., the pitch thereof, the light diffusion screen and the individual control of the light sources.

Patterns with sharp brightness variations between alternating bright and dark stripes are interesting for detecting and evaluating surface defects of large scale like bumps or dents. The reason is that the defect extends over the width of the stripes and will therefore be rendered visible by deformation of the frontier between the bright and dark stripes.

Patterns with progressive brightness variations between alternating bright and dark stripes are interesting for detecting and evaluating surface defects of smaller scale like inclusion of dust and/or fibre in the paint, or also like paint running. Such defects are likely to be completely included in a stripe of a pattern with sharp brightness variations between alternating bright and dark stripes. With a pattern with progressive brightness variations between alternating bright and dark stripes, the defect is more likely to extend to a greyscale level transition between bright and dark and thereby be rendered visible.

The above is illustrated in FIG. 12 which shows at the left a pattern with sharp brightness variations between alternating bright and dark stripes where the defect being a grain inclusion in the paint, is not visible. At the right, use is made of a pattern with progressive brightness variations between alternating bright and dark stripes where the defect is well visible.

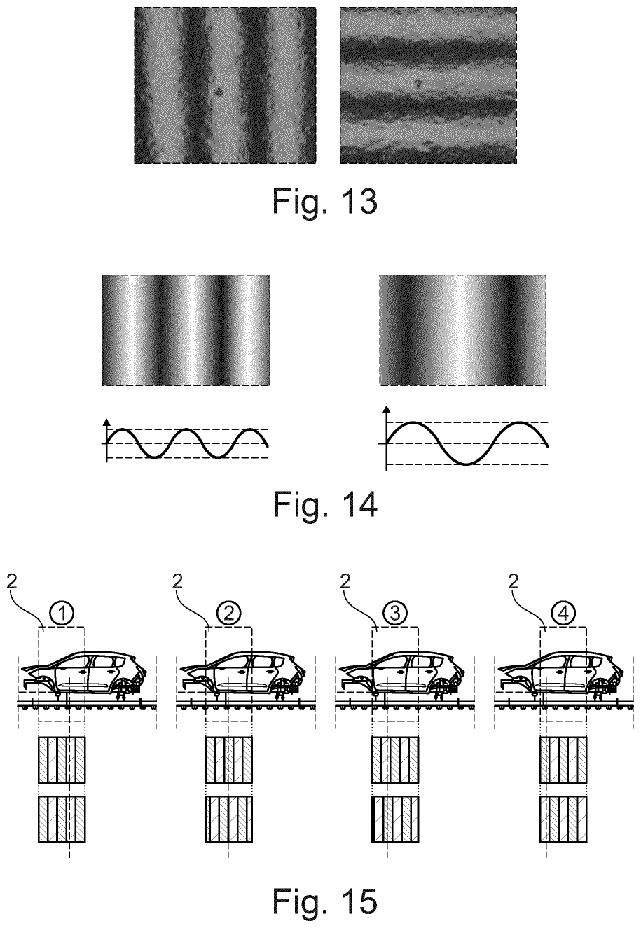

FIG. 13 shows two patterns with progressive brightness variations between alternating bright and dark stripes where the one at the left is oriented longitudinally and the one at the right is oriented transversally. It can be seen that a defect being for instance an inclusion in the paint is revealed by each pattern. If the defect shows an elongate shape, using two such patterns is useful for a better identification.

FIG. 14 shows two patterns with progressive brightness variations between alternating bright and dark stripes and different periods. The pattern at the right shows a longer period than the pattern at the left. The inspection tunnel of the invention allows not only to select the type of pattern but also to adjust its shape, for instance the period. This can be particularly useful for focusing on defects of given scales.

FIG. 15 illustrates in a comparative manner the effect and advantage of having a dynamic illumination pattern that moves in the same direction as the object to be inspected rather than a static one.

The views 1, 2, 3 and 4 correspond to successive stages where the object to be inspected is moving forward (i.e., from the right to the left) relative to the inspection tunnel 2.

At stage 1, the illumination pattern emitted by the inspection tunnel 2 covers a rear portion of the front wing and the front door, whereas at stages 2, 3 and 4 the illumination pattern progressively leaves the front wing and reaches the rear door. A vertical reference line fixed with the object is represented. The upper illumination pattern is static while the lower one is dynamic.

At stage 1, the reference line is on a bright stripe of each of the static and dynamic patterns.

At stage 2, the reference line has left the bright stripe and reached the dark stripe of the static pattern, whereas it is still at the border between the bright and dark stripes of the dynamic pattern. In other words, the relative speed between the moving object to be inspected and the illumination pattern is lowered with the dynamic patter, for the latter moves in the same direction as the object but at a lower speed. At stage 4, compared with stage 1, it can be observed that the reference line has moved over one period of the dynamic pattern whereas it has over about one and a half period of the static pattern.

The above dynamic pattern is particularly interesting for providing more time to operators proceeding to visual inspection of the pattern reflected by a moving object.

The control unit of the inspection tunnel can comprise an input for a signal representative of the moving speed of the object to be inspected relative to the inspection tunnel. The control unit can be configured for regulating the moving speed of the dynamic pattern dependent on the moving speed of the object to be inspected, so as to provide a controlled relative speed, e.g., constant.

1.-19. (canceled)

20. An inspection tunnel for illuminating an outer surface of an object to be inspected, said tunnel comprising:
a frame with an arch shape of the inspection tunnel;
light sources distributed on an inner face of the frame, configured for illuminating the outer surface of an object;
a light diffusing screen with an arch shape and extending in front of the light sources;
wherein the light diffusing screen contacts at least some of the light sources.

21. The inspection tunnel according to claim 20, wherein the light diffusion screen forms a continuous arch-shaped strip with two ends and held in contact with the light sources by a pressing force at the two ends.

22. The inspection tunnel according to claim 21, wherein the pressing force at the two ends of the continuous strip is achieved by a stop piece against each of the two ends, respectively.

23. The inspection tunnel according to claim 20, wherein the light diffusion screen comprises a first transparent layer contacting the light sources and a second diffusing layer superimposed on the first transparent layer and forming an outer surface of the inspection tunnel.

24. The inspection tunnel according to claim 20, further comprising boxes arranged side by side and extending along a main axis of the inspection tunnel, the boxes being carried by the frame and supporting the light sources.

25. The inspection tunnel according to claim 24, wherein each box carries one or more circuit boards provided with the light sources oriented towards the main axis of the inspection tunnel.

26. The inspection tunnel according to claim 24, wherein each box forms an inner volume with air contacting a rear face of the light sources so as to cool the light sources.

27. The inspection tunnel according to claim 24, wherein the light sources supported by each of the boxes forms a grid with a pitch of at least one of not more than 10 mm and at least 4 mm.

28. The inspection tunnel according to claim 24, wherein the inspection tunnel shows an inner mean radius, each box showing a width of not more than 10% of the mean radius.

29. The inspection tunnel according to claim 28, wherein the inspection tunnel shows an inner mean radius, each box showing a width of not more than 8% of the mean radius.

30. The inspection tunnel according to claim 20, further comprising a control unit for individually operating the light sources.

31. The inspection tunnel according to claim 30, wherein the light sources and the control unit are configured for selectively forming different illumination patterns.

32. The inspection tunnel according to claim 31, wherein at least one of the illumination patterns forms alternating bright and dark stripes with a progressive grey-level variation therebetween.

33. The inspection tunnel according to claim 32, wherein the at least one illumination pattern is periodic with a period and an orientation that each can be varied.

34. The inspection tunnel according to claim 31, wherein the different illumination patterns can selectively be static or dynamic by moving along a direction.

35. The inspection tunnel according to claim 34, wherein the dynamic illumination patterns move with a speed that is adjustable.

36. The inspection tunnel according to claim 35, wherein the control unit comprises an input for a signal representative of a speed of the object to be inspected relative to the inspection tunnel, the control unit being configured for adjusting the speed of the dynamic illumination patterns at a value that is less than the speed of the object to be inspected.

37. The inspection tunnel according to claim 31, further comprising at least one camera arranged for capturing images of the illumination patterns reflected by the outer surface of the object to be inspected.

38. The inspection tunnel according to claim 37, wherein the control unit is configured for processing the images captured by the at least one camera in order to identify by deflectometry surface defects.

39. The inspection tunnel according to claim 38, wherein the processing of the images captured by the at least one camera uses phase shifting deflectometry.
